(19) United States
(12) Patent Application Publication
(10) Pub. No.: US 2026/0286861 A1
(43) Pub. Date: Sep. 24, 2026

(54) GAS TURBINE STRUCTURAL COMPONENT

(71) Applicant: MTU Aero Engines AG, Muenchen (DE)

(72) Inventor: Magnus MECHLER, Munich (DE)

(21) Appl. No.: 19/039,837

(22) Filed: Jan. 29, 2025

(30) Foreign Application Priority Data
Feb. 5, 2024 (DE) 102024103191.3

(51) Int. Cl. F01D 25/24

(52) U.S. Cl. CPC F01D 25/24; F05D 2220/32; F05D 2230/60; F05D 2250/13

(57) ABSTRACT

A structural component for a gas turbine having: an outer shell, an inner shell, and a support structure that connects the outer shell and the inner shell, and which has: a first plate array including circumferentially spaced-apart first plates, a second plate array including circumferentially spaced-apart second plates, and a rib array including circumferentially spaced-apart ribs; the first and second plate arrays being spaced apart in the axial direction from each other; one of the second plates at least partially covering a space between two circumferentially adjacent first plates, and one rib of the rib array in each case being disposed at this second plate and at one of these two first plates; and one of the first plates partially covering a space between two circumferentially adjacent second plates, and at least one rib of the rib array in each case being disposed at this first plate and at one of these two second plates.

The present invention relates to a structural component for a gas turbine, a gas turbine assembly including the structural component, and a method for manufacturing the structural component.

### BACKGROUND

Gas turbine structural components, such as compressor intermediate cases or the like, are often intended to transfer loads between inner and outer shells, for example (rotor) bearing forces to struts or to a housing or the like.

### SUMMARY OF THE INVENTION

It is an object of an embodiment of the present invention to improve a gas turbine structural component and/or the manufacture thereof.

It is an object of the present invention to provide a structural component, and a method. A gas turbine assembly having at least one structural component as described herein is also provided.

The present invention provides a component for a gas turbine, comprising:
an outer shell (1);
an inner shell (2); and
a support structure (31-33) connecting the outer shell and the inner shell and having:
   a first plate array including circumferentially spaced-apart first plates (31);
   a second plate array including circumferentially spaced-apart second plates (32); and
   a rib array including circumferentially spaced-apart ribs (33);
      wherein
the first and second plate arrays are spaced apart in the axial direction from each other;
at least one of the second plates at least partially covers a space (312) between two circumferentially adjacent first plates, and at least one rib of the rib array is in each case disposed at this second plate and at one of these two first plates; and
at least one of the first plates at least partially covers a space (321) between two circumferentially adjacent second plates, and at least one rib of the rib array is in each case disposed at this first plate and at one of these two second plates.

A gas turbine assembly, in particular a compressor and/or aircraft engine gas turbine assembly, having at least one structural component as described above is also provided.

In accordance with an embodiment of the present invention, a structural component for a gas turbine, in a refinement a structural component of a gas turbine assembly, in one embodiment a structural component for or of a compressor and/or aircraft engine gas turbine assembly, i.e., in particular for (of) an aircraft engine compressor/gas turbine assembly, has a single-or multi-part outer shell. In a particularly preferred embodiment, the structural component may include a section of a (gas) flow duct of the gas turbine, in particular a so-called “compressor intermediate case.” The (gas) flow duct may be disposed or formed in particular between the hereinafter mentioned outer and inner shells or radially outside of the outer shell or radially within the inner shell. In particular, the outer or inner shell may bound the (gas) flow duct radially inwardly or outwardly. The invention is particularly advantageous for such applications, in particular due to the mechanical, thermal and/or structural boundary conditions, but is in no way limited thereto.

In accordance with an embodiment of the present invention, the structural component has a single-or multi-part inner shell which, in a refinement, is disposed, preferably concentrically, (radially) within the outer shell. The outer and inner shells may in particular be axially flush with each other, or the outer shell may extend axially beyond the inner shell at both ends, or the inner shell may extend axially beyond the outer shell at both ends, or the outer shell and inner shell may extend axially beyond the respective other of the two shells at one (axial) end.

In one embodiment, the outer shell is a welded component. In addition or alternatively, in one embodiment, the inner shell is a welded component. For such components, the present invention is particularly advantageous because it can facilitate the making, inspection, and/or repair of welds. In one embodiment, the outer shell may also be a cast component or an additively manufactured component and/or the inner shell may also be a cast component or an additively manufactured component. For such components, the present invention is particularly advantageous because it can facilitate inspection and/or repair, in particular repair welding.f

In accordance with an embodiment of the present invention, the structural component has a single-or multi-part support structure that connects the outer shell and the inner shell (to each other), and which preferably transmits, or is designed to transmit, loads, in particular radial loads, circumferential loads, and/or axial loads, between the outer shell and inner shell. In one embodiment, the support structure is connected to the outer shell and/or the inner shell by material-to-material bonding, in a refinement by welding, brazing, adhesive bonding, or the like, or is integrally formed, in particular by additive manufacturing or casting.

In accordance with an embodiment of the present invention, the support structure has or, in particular, may be composed of a plate array which includes single-or multi-part plates spaced circumferentially apart, preferably uniformly, and which is/are hereinafter referred to as first plate array or first plates without limiting generality, another plate array which includes single-or multi-part plates spaced circumferentially apart, preferably uniformly, and which is/are hereinafter referred to as second plate array or second plates without limiting generality, and a rib array including single-or multi-part ribs spaced circumferentially apart. The first plates/plate array may in particular be (an) upstream plates/plate array, i.e., (a) forward plates/plate array in the direction of flow through the gas turbine, or (a) downstream plates/plate array, i.e., (a) rear plates/plate array in the direction of flow through the gas turbine.

In one embodiment, an axial direction is parallel to a (main) machine axis and/or axis of rotation of the gas turbine and/or longitudinal axis and/or axis of (rotational) symmetry of the structural component, a circumferential direction is accordingly a circumferential direction or direction of rotation about this (main) machine axis or axis of rotation or axial direction, and a radial direction is perpendicular to the axial and circumferential directions.

In one embodiment, one or more of the first plates and/or one or more of the second plates are flat or singly or multiply curved and/or (each) extend radially from the inner shell to the outer shell and/or (each) extend mainly in the circumferential direction and/or radial direction. In addition or alternatively, in one embodiment, one or more of the ribs are flat or singly or multiply curved and/or (each) extend radially from the inner shell to the outer shell and/or (each) extend mainly in the axial direction and/or radial direction. Ribs that are slanted toward the axial direction may also be advantageous, in particular to connect together first and second plates of different dimensions.

In accordance with an embodiment of the present invention, the first and second plate arrays are spaced apart in the axial direction. In a refinement, the first plate array is disposed in the region of an (axial) end of the outer shell and/or of the inner shell, and/or the second plate array is disposed in the region of an (another axial) end of the outer and/or of the inner shell.

In accordance with an embodiment of the present invention, at least one of the second plates completely or partially covers or overlaps a space between two circumferentially adjacent first plates, at least one rib of the rib array being disposed at this second plate and at one of these two first plates, preferably in adjoining relationship thereto, and at least one other rib of the rib array being disposed at this second plate and at the other of these two first plates, preferably in adjoining relationship thereto, and preferably such that these two first plates, these ribs, and this second plate form a blind hole-like pocket when viewed in the circumferential direction. Preferably, two or more, particularly preferably all, of the second plates each completely or partially cover or overlap a space between two circumferentially adjacent first plates, at least one rib of the rib array being disposed at the respective second plate and at one of these respective two first plates, preferably in adjoining relationship thereto, and at least one other rib of the rib array being disposed at this second plate and at the other of these respective two first plates, preferably in adjoining relationship thereto.

In accordance with an embodiment of the present invention, at least one of the first plates completely or partially covers or overlaps a space between two circumferentially adjacent second plates, at least one rib of the rib array being disposed at this first plate and at one of these two second plates, preferably in adjoining relationship thereto, and at least one other rib of the rib array being disposed at this first plate and at the other of these two second plates, preferably in adjoining relationship thereto, and preferably such that these two second plates, these ribs, and this first plate form a blind hole-like pocket when viewed in the circumferential direction. Preferably, two or more, particularly preferably all, of the first plates each completely or partially cover or overlap a space between two circumferentially adjacent second plates, at least one rib of the rib array being disposed at the respective first plate and at one of these respective two second plates, preferably in adjoining relationship thereto, and at least one other rib of the rib array being disposed at this first plate and at the other of these respective two second plates, preferably in adjoining relationship thereto.

Thus, particularly preferably, first plates and second plates (circumferentially offset from the first plates) are alternately arranged when viewed in the circumferential direction, at least one of the ribs being disposed at each of the circumferentially successive plates, in particular in adjoining relationship thereto, so that, in one embodiment, the support structure has a meandering shape or configuration in the circumferential direction.

In an embodiment, this makes it possible, firstly, to achieve a particularly advantageous load distribution in the structural component and/or a particularly advantageous load transfer between the inner and outer shells, and secondly, to allow access to the space between the inner and outer shells, in particular for purposes of manufacture and/or inspection and/or repair of the structural component, particularly for the making and/or inspection of welds or the like.

In one embodiment, one or more of the first plates and/or one or more of the second plates and/or one or more of the ribs (each) have at least one cavity or are at least partially hollow or not formed as (a) solid component(s). In one embodiment, this makes it advantageously possible to reduce weight.

In addition or alternatively, in one embodiment, one or more of the first plates and/or one or more of the second plates are (each) configured in a trapezoid-like shape, preferably in a shape similar to an isosceles trapezoid.

In addition or alternatively, in one embodiment, one or more of the plates (each) have an end side facing the outer shell (i.e., a radially outer end side), and an end side facing the inner shell (i.e., a radially inner end side); an, in particular minimum and/or maximum and/or mean, circumferential extent of this outer-shell-facing end side being greater than an, in particular minimum and/or maximum and/or mean, circumferential extent of this inner-shell-facing end side. In addition or alternatively, in one embodiment, one or more (different ones) of the plates (each) have an end side facing the outer shell (i.e., a radially outer end side), and an end side facing the inner shell (i.e., a radially inner end side); an, in particular minimum and/or maximum and/or mean, circumferential extent of this outer-shell-facing end side being smaller than an, in particular minimum and/or maximum and/or mean, circumferential extent of this inner-shell-facing end side.

Accordingly, in one embodiment, one or more of the first plates (each) have an outer-shell-facing end side that is longer than its/their inner-shell-facing end side in the circumferential direction and/or one or more of the second plates (each) have an outer-shell-facing end side that is shorter than its/their inner-shell-facing end side in the circumferential direction, or conversely, one or more of the first plates (each) have an outer-shell-facing end side that is shorter than its/their inner-shell-facing end side in the circumferential direction and/or one or more of the second plates (each) have an outer-shell-facing end side that is longer than its/their inner-shell-facing end side in the circumferential direction.

Accordingly, in a particularly advantageous combination of the aforementioned features, one or more of the first and/or second plates are configured in a trapezoid-like shape, preferably in a shape similar to an isosceles trapezoid. Particularly advantageously, the outer-shell-facing end side of these first plates forms the, preferably curved, major base, and their inner-shell-facing end side forms the, preferably curved, other or shorter base side of the trapezoid, and/or the inner-shell-facing end side of these second plates forms the, preferably curved, major base, and their outer-shell-facing end side forms the, preferably curved, other or shorter base side of the trapezoid, or conversely, the inner-shell-facing end side of these first plates forms the, preferably curved, major base, and their outer-shell-facing end side forms the, preferably curved, other or shorter base side of the trapezoid, and/or the outer-shell-facing end side of these second plates forms the, preferably curved, major base, and their inner-shell-facing end side forms the, preferably curved, other or shorter base side of the trapezoid.

In addition or alternatively, in one embodiment, one or more plates of one of the two plate arrays are longer than one or more, preferably all, of the plates of the other of the two plate arrays in the circumferential direction, in particular in absolute terms and/or based on an, in particular maximum, minimum and/or mean, circumference of the (respective) plate array. Accordingly, in one embodiment, first plates are longer than second plates in the circumferential direction, or conversely, second plates are longer than first plates in the circumferential direction. If one of the two plate arrays has a larger maximum outer diameter or circumference than the other of the two plate arrays, plates of the plate array with the larger outer diameter or circumference may, for example, be longer than plates of the plate array with the smaller outer diameter or circumference when considered in absolute terms, but shorter when considered relative to or based on the larger outer circumference of their plate array. In particular, the term “longer” may refer to a (maximum) angular range covered by the respective plate or may correspond to a larger angular range covered.

In addition or alternatively, one or more of the plates of one of the two plate arrays, which (each) at least partially cover a space between two circumferentially adjacent plates of the other of the two plate arrays, at least partially cover or overlap one or both of these (respective) two plates of the other plate array in the circumferential direction. In addition or alternatively, one or more of the plates of one of the two plate arrays, which (each) at least partially cover a space between two circumferentially adjacent plates of the other of the two plate arrays, do not cover or overlap one or both of these (respective) two plates of the other plate array at all or/or not partially in the circumferential direction. In other words, first plates may be disposed (completely or only) in the spaces between second plates and/or second plates may be disposed (completely or only) in the spaces between first plates and/or first plates may at least partially cover or overlap second plates on one or both sides and/or second plates may at least partially cover or overlap first plates on one or both sides. As used herein, “(partial) covering” is understood generally and, in particular, as is customary in the art to mean that projections in the axial direction (partially) coincide.

In addition or alternatively, in one embodiment, the first shell and/or the second shell covers the rib array, and in a refinement also the first plates and/or the second plates, and accordingly, in one embodiment, the (entire) support structure, in particular radially outwardly and/or radially inwardly.

In addition or alternatively, in one embodiment, the support structure extends over the entire inner circumference of the outer shell and/or over the entire outer circumference of the inner shell.

In one embodiment, a particularly advantageous load distribution in the structural component and/or a particularly advantageous load transfer between the inner and outer shells can be achieved by one or more of the aforementioned (geometry) features.

In one embodiment, one or more of the first plates are formed integrally with, or connected by material-to-material bonding to, one (each) or more of the ribs disposed at the respective first plate.

In addition or alternatively, in one embodiment, one or more of the second plates are formed integrally with, or connected by material-to-material bonding to, one (each) or more of the ribs disposed at the respective second plate.

In addition or alternatively, in one embodiment, one or more of the first plates and/or one or more of the second plates are formed integrally with, or connected by material-to-material bonding to, the outer shell.

In addition or alternatively, in one embodiment, one or more of the first plates and/or one or more of the second plates are formed integrally with, or connected by material-to-material bonding to, the inner shell.

In addition or alternatively, in one embodiment, one or more of the ribs are formed integrally with, or connected by material-to-material bonding to, the outer shell.

In addition or alternatively, in one embodiment, one or more of the ribs are formed integrally with, or connected by material-to-material bonding to, the inner shell.

An integral design can, in an embodiment, improve the load flow, a material-to-material bond can in particular improve manufacture.

In one embodiment, the inner shell is connected to an inner bearing, preferably for a rotor of the gas turbine, and/or the outer shell is directly or indirectly connected, preferably fastened to, a casing, preferably a casing of the gas turbine, in one embodiment via struts. The present invention is particularly advantageous for such load flows.

In accordance with an embodiment of the present invention, a method for manufacturing a structural component as described herein includes connecting, by material-to-material bonding, two or more of the components of the structural component to one another, in one embodiment ribs to first plates and/or second plates, and/or ribs, first plates and/or second plates to the outer shell and/or the inner shell, and/or forming two or more of the components of the structural component integrally with each other, in one embodiment ribs with first plates and/or second plates, and/or second ribs, first plates and/or second plates with the outer shell and/or the inner shell.

### BRIEF DESCRIPTION OF THE DRAWINGS

Further advantageous refinements of the present invention will become apparent from the dependent claims and the following description of preferred embodiments. To this end, the drawings show, partly in schematic form, in:

FIG. 1: a side view of a structural component according to an embodiment of the present invention;

FIG. 2: an axial plan view of the structural component;

FIG. 3: an axial sectional view through the first plate array of the structural component, taken along line III-III of FIG. 1;

FIG. 4: an axial sectional view taken along line IV-IV of FIG. 1 between the first plate array and a second plate array of the structural component;

FIG. 5: an axial sectional view through the second plate array, taken along line V-V of FIG. 1;

FIG. 6: a side view of a structural component according to another embodiment of the present invention.

### DETAILED DESCRIPTION

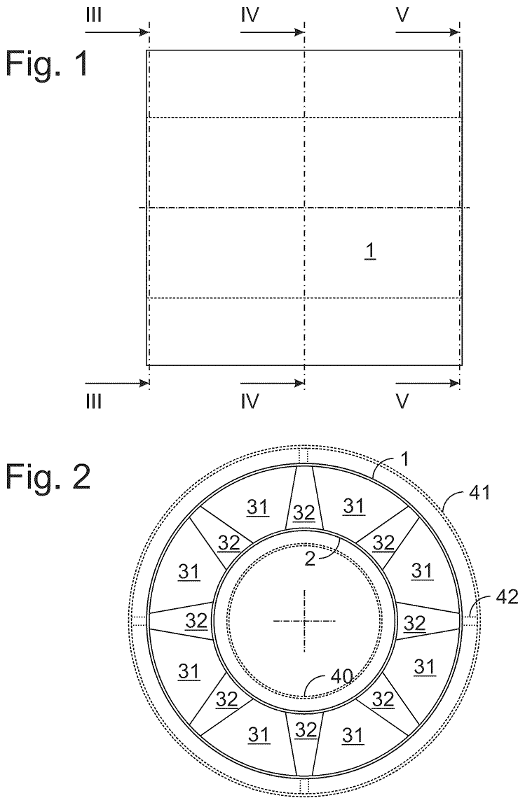

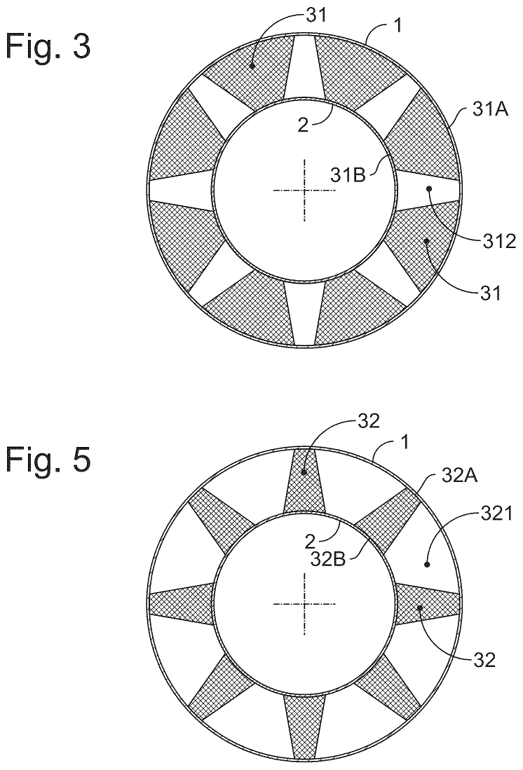

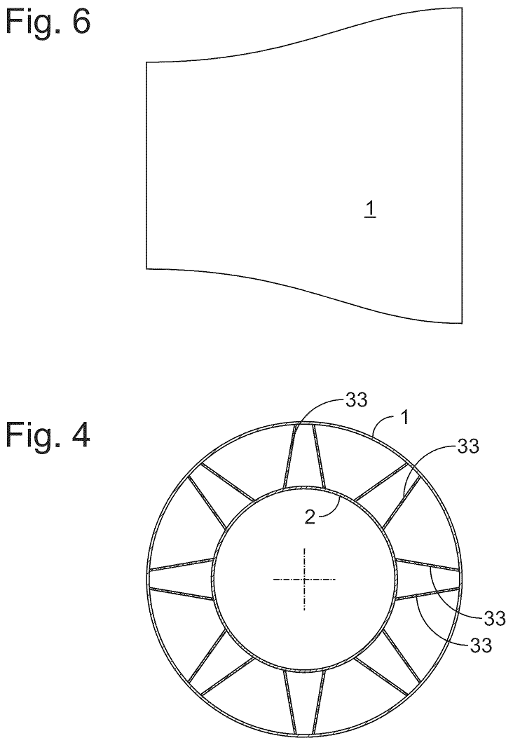

FIGS. 1, 2 show a structural component for or of a gas turbine according to an embodiment of the present invention in a side view (FIG. 1) and an axial plan view (FIG. 2). FIGS. 3-5 show axial sectional views perpendicular to the (main) machine or longitudinal axis (horizontal in FIG. 1).

The structural component has an outer shell 1, an inner shell 2, and a support structure that connects outer shell 1 and inner shell 2, and which has a first plate array including circumferentially spaced-apart first plates 31, a second plate array including circumferentially spaced-apart second plates 32, and a rib array including circumferentially spaced-apart ribs 33.

As illustrated in particular by the axial sectional views of FIGS. 3-5, the first plate array and the second plate array are spaced apart in the axial direction from each other.

As illustrated in particular by the axial plan view of FIG. 2 in conjunction with the axial sectional views of FIGS. 3-5, each of the second plates 32 at least partially covers a space 312 between two circumferentially adjacent first plates 31, with one rib 33 of the rib array in each case being disposed at the respective second plate 32 and at one of the respective two first plates 31, and a circumferentially adjacent rib 33 of the rib array being disposed at this second plate 32 and at the other of the respective two first plates 31, and each of the first plates 31 at least partially covers a space 321 between two circumferentially adjacent second plates 32, with one rib 33 of the rib array in each case being disposed at the respective first plate 31 and at one of the respective two second plates 32, and a circumferentially adjacent rib 33 of the rib array being disposed at this first plate 31 and at the other of the respective two second plates 32.

The plates 31, 32 are configured in a trapezoid-like shape. In the exemplary embodiment, first plates 31 have an end side 31A facing the outer shell and an end side 31B facing the inner shell, a circumferential extent of the outer-shell-facing end side 31A being greater than a circumferential extent of the inner-shell-facing end face 31B. Conversely, in the case of second plates 32, a circumferential extent of an outer-shell-facing end side 32A is smaller than a circumferential extent of the inner-shell-facing end side 32B.

In the exemplary embodiment, first plates 31 of the first plate array are longer than second plates 32 of the second plate array in the circumferential direction.

As illustrated in particular by FIG. 1, shells 1, 2 cover support structure 31-33, which in turn extends over the entire (radially) inner circumference of the outer shell and the entire (radially) outer circumference of the inner shell.

The inner shell may be connected to an inner bearing 40 of the gas turbine; the outer shell may be connected, for example via struts 42, to a casing 41 of the gas turbine, which is indicated schematically by dashed lines only in FIG. 2.

The exemplary embodiment illustrates in particular that the major portion of the inner peripheral surface of outer shell 1 and that of the outer peripheral surface of inner shell 2 are advantageously accessible through one of the spaces 312, 321 between circumferentially adjacent ribs 33.

In the present disclosure, “has an X” generally does not imply an exhaustive enumeration, but rather is short for “has at least one X” and includes also “has two or more X” as well as “has Y in addition to X.” While exemplary embodiments have been presented in the foregoing detailed description, it should be appreciated that many modifications are possible.

Thus, for simplified presentation, outer and inner shells 1, 2 are shown in cylindrical form, but one or both of the shells may, of course and particularly advantageously, also be conical, tapered, or otherwise in shape. Accordingly, in a preferred embodiment, the first plate array has a first (maximum) outer diameter and the second plate array has a larger or smaller (maximum) outer diameter. In this regard, FIG. 6 exemplarily shows a side view of a structural component according to another embodiment of the present invention, which in all other respects may be identical to the above embodiment of FIGS. 1-5.

It should also be appreciated that the exemplary embodiments are only examples, and are not intended to limit the scope, applicability, or configuration in any way. Rather, the foregoing detailed description will provide those skilled in the art with a convenient road map for implementing at least one exemplary embodiment, it being understood that various changes may be made in the function and arrangement of elements described without departing from the scope of protection as set forth in the appended claims or derived from combinations of features equivalent thereto.

### LIST OF REFERENCE NUMERALS

1 outer shell
2 inner shell
31 first plate (array)
32 second plate (array)
33 rib (array)
31A, 32A end side facing the outer shell
31B, 32B end side facing the inner shell
40 bearing
41 casing
42 strut
312 space between adjacent first plates
321 space between adjacent second plates

What is claimed is:

1-11. (canceled)

12. A component for a gas turbine, the component comprising:
an outer shell;
an inner shell; and
a support structure connecting the outer shell and the inner shell and having:
a first plate array including circumferentially spaced-apart first plates;
a second plate array including circumferentially spaced-apart second plates; and
a rib array including circumferentially spaced-apart ribs;
wherein
the first and second plate arrays are spaced apart in an axial direction from each other;
at least one of the second plates at least partially covers, when viewed in the axial direction, a space between two circumferentially adjacent first plates, and at least one rib of the rib array is in each case disposed at the respective second plate and at one of the respective two first plates; and
at least one of the first plates at least partially covers a space between two circumferentially adjacent second plates, and at least one further rib of the rib array is in each case disposed at the respective first plate and at one of the respective two second plates.

13. The structural component as recited in claim 12 wherein at least one of the first or second plates is configured in a trapezoid-like shape.

14. The structural component as recited in claim 12 wherein at least one of the first or second plates or at least one of the ribs has at least one cavity.

15. The structural component as recited in claim 12 wherein at least one of the first or second plates has an end side facing the outer shell and an end side facing the inner shell, a circumferential extent of the outer-shell-facing end side being greater than a circumferential extent of the inner-shell-facing end face.

16. The structural component as recited in claim 12 wherein at least one of the first or second plates has an end side facing the outer shell and an end side facing the inner shell, a circumferential extent of the outer-shell-facing end side being smaller than a circumferential extent of the inner-shell-facing end face.

17. The structural component as recited in claim 12 wherein the one of the first and second plates are longer than the other of the first and second plates in the circumferential direction.

18. The structural component as recited in claim 12 wherein one of the first and second plates at least partially covers the of the first and second plates when viewed in the axial direction.

19. The structural component as recited in claim 12 wherein at least one of the first and second plates does not cover at least one of the other of the first and second plates, or in that at least one of the shells covers the rib array.

20. The structural component as recited in claim 12 wherein the support structure extends over an entirety of an inner circumference of the outer shell or an entirety of an outer circumference of the inner shell.

21. The structural component as recited in claim 12 wherein
at least one of the first plates is formed integrally with, or connected by a material-to-material bond to, at least one of the ribs disposed thereat; or
at least one of second plates is formed integrally with, or connected by a material-to-material bond to, at least one of the ribs disposed thereat; or
at least one of the first plates is formed integrally with, or connected by a material-to-material bond to, the outer shell or the inner shell; or
at least one of the second plates is formed integrally with, or connected by a material-to-material bond to, the outer shell or the inner shell; or
at least one of the ribs is formed integrally with, or connected by a material-to-material bond to, the outer shell or the inner shell.

22. The structural component as recited in claim 12 wherein the inner shell is connected to an inner bearing or the outer shell is connected to a casing.

23. The structural component as recited in claim 12 wherein the inner shell is connected to an inner bearing or the outer shell is connected via struts to a casing.

24. A gas turbine assembly, in particular a compressor or aircraft engine gas turbine assembly, comprising the structural component as recited in claim 12.

25. A compressor or aircraft engine gas turbine assembl, comprising the structural component as recited in claim 12.

26. A method for manufacturing the structural component as recited in claim 12, the method comprising at least one of the steps of:
connecting, by material-to-material bonding, at least two of the components of the structural component to one another; or
forming at least two of the components of the structural component integrally with each other.
